(19) United States
(12) Patent Application Publication
(10) Pub. No.: US 2001/0048551 A1
(43) Pub. Date: Dec. 6, 2001

(54) Microscope unit

(75) Inventor: Shinobu Sakamoto, Tokyo (JP)

Correspondence Address: STAAS & HALSEY LLP, 700 11TH STREET, NW, SUITE 500, WASHINGTON, DC, 20001, US

(73) Assignee: NIKON CORPORATION, Tokyo (JP)

(21) Appl. No.: 09/863,249

(22) Filed: May 24, 2001

(30) Foreign Application Priority Data
Jun. 5, 2000 (JP) 2000-167871

(51) Int. Cl. G02B 21/00

(52) U.S. Cl. 359/381; 359/368; 359/383

(57) ABSTRACT

A microscope unit of the present invention having a supplementary lens by means of which the distance between a view object and the viewing end of a microscope is adjustable. The unit has an intermediate member which is attachable between the microscope viewing end and the supplementary lens and has a dimension in the direction of the optical axis, where a first engagement part which is detachably fastenable to a lens attachment part at the microscope viewing end and a second engagement part which is detachably fastenable to the supplementary lens are formed in the intermediate member.

This microscope unit enables selection of working distance in great variety, without taking time and cost for, e.g., preparing attachment lenses additionally.

This application claims the benefit of Japanese Patent application No. 2000-167871 which is hereby incorporated by reference.

### BACKGROUND OF THE INVENTION

1. Field of the Invention

This invention relates to a microscope unit, and more particularly to a microscope unit to be built in an inspection mechanism or an assembly mechanism and used for the monitoring of products.

2. Related Background Art

Microscope units are not only used to observe objects placed on sample stages, but also often built in inspection mechanisms or assembly mechanism and used for the monitoring of products.

An instance in which a microscope unit is built in a wire bonder which is an assembly mechanism for semiconductors such as IC chips is described below with reference to FIG. 4 which illustrates the relationship between the microscope unit and a semiconductor chip.

A semiconductor chip 250 is attached to a die pad with an alloy (gold and silicon) or the like (i.e., die bonding); the die pad being provided on a lead frame (not shown). Thin wires of about 25 μm are further connected to terminals of the lead frame by means of a bonding head 240. Such wires are bonded watching the operation with a microscope unit 200.

Between the viewing end of a microscope 210 and the semiconductor chip, however, there are obstacles such as the bonding head 240 and a wire feeder (not shown). Accordingly, the microscope unit 200 is held by a mount 214 attached downward with an arm 215 which extends from an assembly mechanism (not shown); the microscope unit being so held that its optical axis L stands oblique to the semiconductor chip 250 so as to be kept away from the obstacles. Constructed in this manner, the semiconductor chip 250 can be observed without being obstructed by the bonding head 240 and so forth.

Now, a stereomicroscope is usually built in the wire bonder to observe how the wires stretch and the bonding proceeds. This stereomicroscope is provided at a working distance (distance between an object and the microscope viewing end) D1 which is in such an extent that its viewing is not obstructed. When, however, there is the obstacle as shown in FIG. 4, the working distance D1 must be changed in order to avoid the obstacle. Accordingly, an attachment lens 230 as shown in FIG. 5, prepared previously is conventionally used to adjust the working distance so as to be favorable for microscopic observation.

FIG. 5 illustrates the relationship between the microscope unit and a semiconductor chip when the attachment lens is joined. The same components as those in FIG. 4 are denoted by like reference numerals to omit description from repeating.

The attachment lens 230 is attached to a lens attachment part (not shown) provided at the viewing end of the microscope 210. Usually, a concave lens 231 is used in the attachment lens 230, and hence the semiconductor chip 250 can be positioned at position P2 when the attachment lens 230 is attached. Incidentally, when the attachment lens 230 is not attached, the position of the semiconductor chip 250 is indicated by P1. Because of this attachment lens, the working distance D1 (FIG. 4) is elongated to D2, resulting in a larger distance between the semiconductor chip 250 and the viewing end of the microscope.

The necessary working distance, however, differs depending on assembly mechanisms used. To make adaptation to such difference, it has been usual to make it ready to use a plurality of attachment lenses having different working distance (having different focal length). For example, in respect of a microscope unit having a working distance of 100 mm in the state it has no attachment lens, attachment lenses of 130 mm, 180 mm, 230 mm and 280 mm in working distance are made ready for use as accessories.

When, however, a working distance other than that of attachment lenses made ready is required, it is necessary to prepare an attachment lens additionally or to change the position at which the microscope is attached to the mount of the assembly mechanism, bringing about a problem that it takes much time and cost.

### SUMMARY OF THE INVENTION

The present invention was made taking account of such circumstances. Accordingly, an object of the present invention is to provide a microscope unit which enables selection of working distance in great variety, without taking time and cost for, e.g., preparing attachment lenses additionally.

To achieve the above object, a first aspect of the present invention provides a microscope unit having a supplementary lens by means of which the distance between a view object and the viewing end of a microscope is adjustable, wherein;

the unit comprises an intermediate member which is attachable between the microscope viewing end and the supplementary lens and has a dimension in the direction of the optical axis, and a first engagement part which is detachably fastenable to a lens attachment part at the microscope viewing end and a second engagement part which is detachably fastenable to the supplementary lens are formed in the intermediate member.

The first engagement part of the intermediate member may be fastened to the lens attachment part at the microscope viewing end and the second engagement part may be fastened to the supplementary lens, whereby any desired working distance can be set.

A second aspect of the present invention also provides, as a second embodiment, a microscope unit having a supplementary lens by means of which the distance between a view object and the viewing end of a microscope is adjustable, wherein;

the unit comprises one intermediate member which is attachable between the microscope viewing end and the supplementary lens and is selected from a plurality of intermediate members each having a different dimension in the direction of the optical axis, and a first engagement part which is detachably fastenable to a lens attachment part at the microscope viewing end and a second engagement part which is detachably fastenable to the supplementary lens are formed in the intermediate member.

The first engagement part of the intermediate member selected may be fastened to the lens attachment part at the microscope viewing end and the second engagement part may be fastened to the supplementary lens, whereby any desired working distance can be selected.

A third aspect of the present invention still also provides a microscope unit having a supplementary lens by means of which the distance between a view object and the viewing end of a microscope is adjustable, wherein;

the unit comprises an intermediate member which is attachable between the microscope viewing end and the supplementary lens and has a plurality of ring members standing connected, each having a different dimension in the direction of the optical axis, and i) a microscope-side attachment part having a first engagement part which is detachably fastenable to a lens attachment part at the microscope viewing end and ii) a supplementary-lens-side attachment part having a second engagement part which is detachably fastenable to the supplementary lens and being attached to the microscope-side attachment part movably in the direction of the optical axis are provided in the ring members of the intermediate member.

The first engagement part of the microscope-side attachment part may be fastened to the lens attachment part at the microscope viewing end and the second engagement part of the supplementary-lens-side attachment part may be fastened to the supplementary lens, where the supplementary-lens-side attachment part may be moved with respect to the microscope-side attachment part in the direction of the optical axis to select any desired working distance.

According to the first and second aspects of the microscope unit of the present invention, the working distance can be selected in variety using a small number of attachment lenses, without taking time and cost for, e.g., preparing attachment lenses additionally and changing the position at which the microscope is attached. Also, when the assembly mechanism is designed, it can be designed at a higher degree of freedom without any restriction on the position at which the microscope is attached.

According to the third aspect of the microscope unit of the present invention, the working distance can be selected in greater variety than the microscope of the first or second aspect. Also, since the working distance is variable, the distance between the object and the microscope can be varied continuously. Thus, it follows that the microscope can also be focused by turning the intermediate member (adapter), bringing about an improvement in the operability of the microscope unit.

### BRIEF DESCRIPTION OF THE DRAWINGS

FIG. 1 is a partially broken side view of the microscope unit according to an embodiment of the present invention.

FIG. 2 illustrates the relationship between an object, an attachment lens and an image where a concave lens 31 is a thin lens.

FIG. 3 is a partially broken side view of the microscope unit according to another embodiment of the present invention.

FIG. 4 illustrates the relationship between a microscope unit and a semiconductor chip.

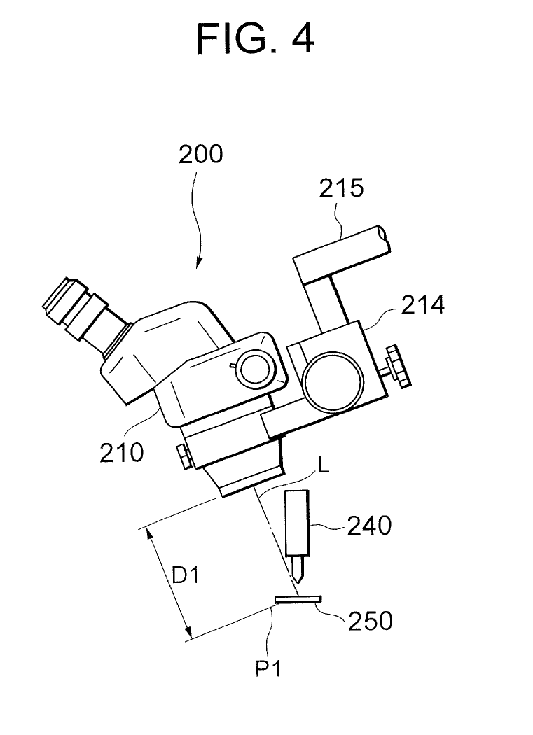

FIG. 5 illustrates the relationship between a microscope unit and a semiconductor chip when an attachment lens is joined.

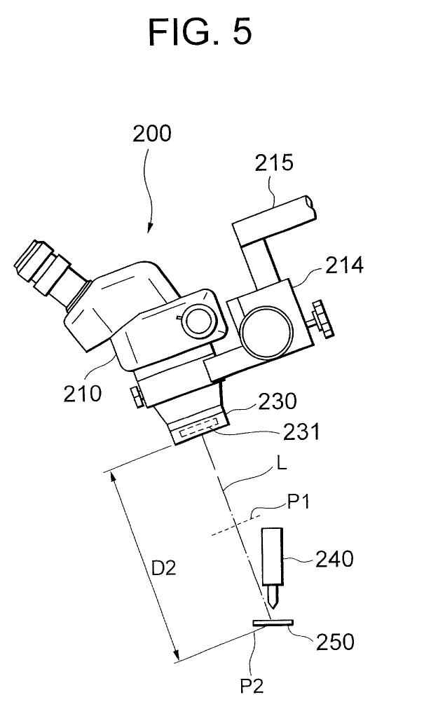

### DESCRIPTION OF THE PREFERRED EMBODIMENTS

The microscope unit of the present invention has a supplementary lens by means of which the distance between a view object and the viewing end of a microscope (herein often “microscope viewing end”) is adjustable. The unit is characterized by having an intermediate member which is attachable between the microscope viewing end and the supplementary lens and has a dimension (thickness) in the direction of the optical axis, where a first engagement part which is detachably fastenable to a lens attachment part at the microscope viewing end and a second engagement part which is detachably fastenable to the supplementary lens are formed in the intermediate member.

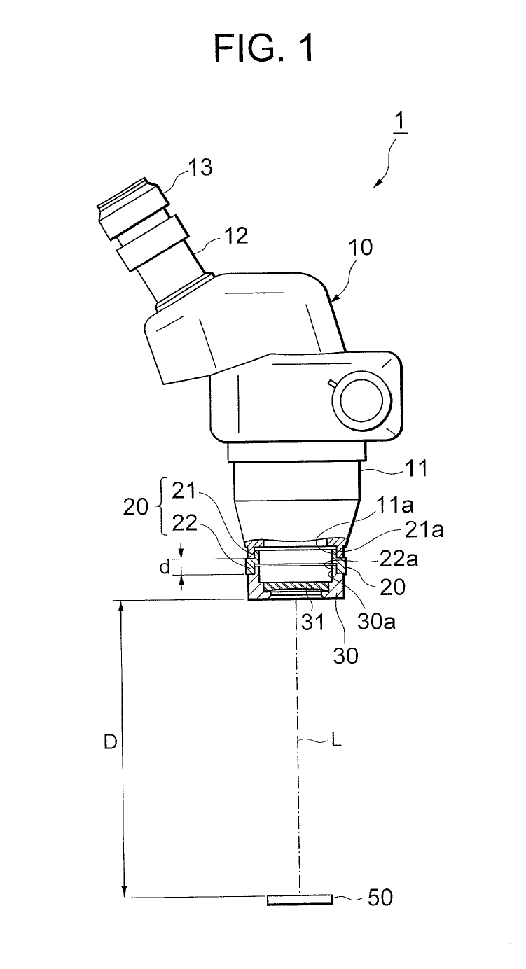

FIG. 1 is a partially broken side view of the microscope unit according to the first embodiment of the present invention.

As shown in FIG. 1, a microscope unit 1 has a microscope unit 10, an adapter 20 (the intermediate member) and an attachment lens 30 (the supplementary lens).

The microscope 10 has a microscope main body 11 and a lens barrel 12. The lens barrel 12 is provided with an eyepiece 13 at which an image of an object 50, formed through an objective lens (not shown), is magnified so as to be viewable to the naked eye.

The adapter (intermediate member) 20 has a small-diameter portion 21 and a large-diameter portion 22 and has a thickness d (the dimension in the direction of the optical axis). A plurality of adapters (intermediate members) having different thickness may be made ready for use so that any one of them may be selected and used (the second embodiment).

The small-diameter portion 21 of the adapter 20 has a male thread 21a (the first engagement part) formed on its outer periphery. This male thread 21a stands engaged with a female thread 11a (the lens attachment part) formed at the viewing end of the microscope main body 11 (microscope 10).

The large-diameter portion 22 of the adapter 20 has a female thread 22a (the second engagement part) formed on its inner periphery. This female thread 22a stands engaged with a male thread 30a of the attachment lens 30.

The attachment lens (supplementary lens) 30 is internally provided with a concave lens 31, and by this concave lens 31 the working distance (focal length) D of the attachment lens 30 is changed. As the attachment lens 30, a plurality of attachment lenses of, e.g., 130 mm, 180 mm, 230 mm and 280 mm in working distance are made ready for use.

The working distance is determined in the following way.

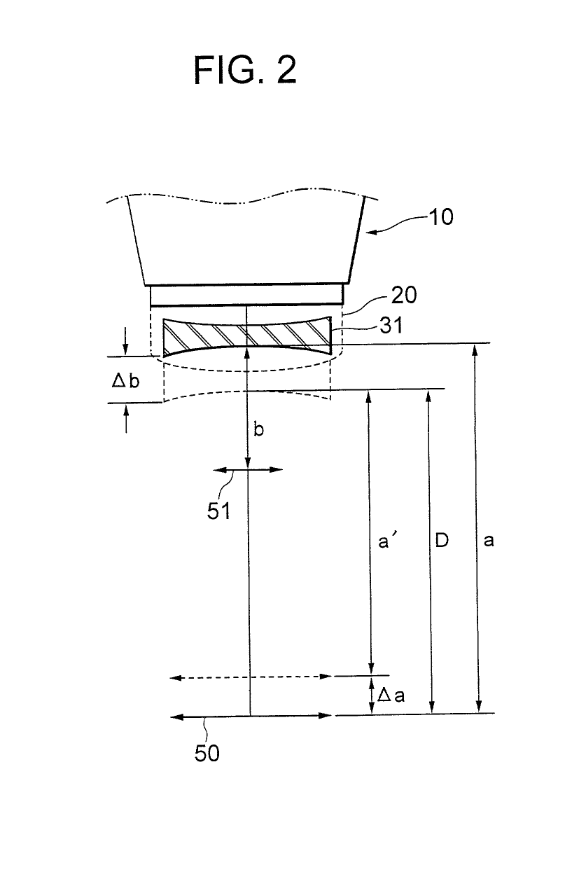

FIG. 2 illustrates the relationship between an object, an attachment lens and an image where the concave lens 31 is a thin lens. In FIG. 2, the adapter 20 shown by a solid line stands before it is attached, and the adapter 20 shown by a dotted line stands after it has been attached.

Where the distance between the object 50 and the concave lens 31 is represented by a, and the distance between an image plane 51 and the concave lens 31 by b, magnification β of the attachment lens 30 can be determined from

β=b/a (1)

and change in distance between the object 50 and the concave lens 31, Δa, can be determined from

Δa=Δb/β² (2)

where Δb is the extent of change in distance between the image plane 51 and the concave lens 31.

For example, where a=245 mm and b=100 mm, it follows from the equation (1) that β=0.4.

Where the thickness d of the adapter 20 is d=3.5 mm, the extent of change, Δb, is given by Δb=−3.5 mm, and it follows from the equation (2) that Δa≈−20 mm. Namely, it follows that the working distance (a′ in FIG. 2) is (D−20) mm.

According to the above first and second embodiments, only the adapter (intermediate member) 20 may be replaced so that the working distance can be selected in variety using a small number of attachment lenses 30, without taking time and cost for, e.g., preparing attachment lenses additionally and changing the position at which the microscope is attached. Also, when the assembly mechanism is designed, it can be designed at a higher degree of freedom without any restriction on the position at which the microscope 10 is attached.

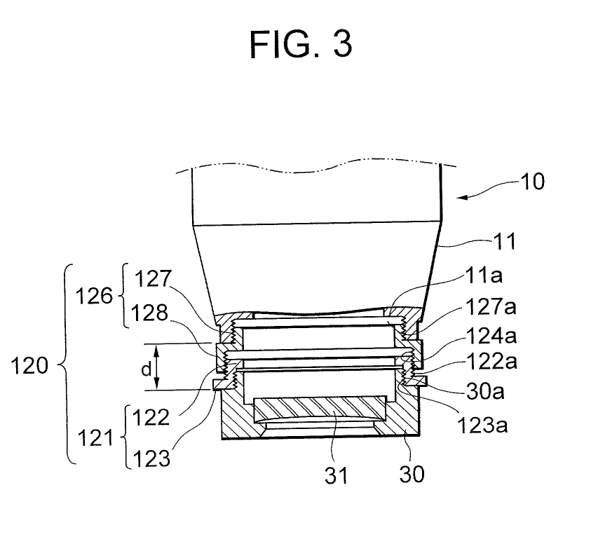

FIG. 3 is a partially broken side view of the microscope unit according to the third embodiment of the present invention. The same components as those in the first and second embodiments are denoted by like reference numerals to omit description from repeating.

An adapter 120 (the intermediate member) has a microscope-side attachment part 126 and a supplementary-lens-side attachment part 121.

The microscope-side attachment part 126 is ring-shaped and has a small-diameter portion 127 and a large-diameter portion 128.

The small-diameter portion 127 of the microscope-side attachment part 126 has a male thread 127a (the first engagement part) formed on its outer periphery. This male thread 127a stands engaged with a female thread 11a (the lens attachment part) formed at the viewing end of the microscope main body 11 (microscope 10). Also, the large-diameter portion 128 of the microscope-side attachment part 126 has a female thread 124a formed on its inner periphery.

The supplementary-lens-side attachment part 121 is ring-shaped and has a small-diameter portion 122 and a large-diameter portion 123.

The large-diameter portion 123 of the supplementary-lens-side attachment part 121 has a female thread 123a (the second engagement part) formed on its inner periphery. This female thread 123a stands engaged with a male thread 30a of the attachment lens 30. Also, the small-diameter portion 122 of the supplementary-lens-side attachment part 121 has a male thread 122a (the first engagement part) formed on its outer periphery. This male thread 122a stands engaged with a female thread 124a formed on the inner periphery of the large-diameter portion 128 of the microscope-side attachment part 126.

The supplementary-lens-side attachment part 121 may be turned to change the thickness d of the adapter 120 (the dimension of the adapter 120 in the direction of the optical axis). The extent of change in working distance may be determined in the same manner as in the first embodiment.

According to this embodiment, the working distance can be selected in greater variety than the the first and second embodiments. Also, since the working distance is variable, the distance between the object 50 (see FIG. 1) and the microscope 10 can be varied continuously. Thus, it follows that the microscope can also be focused by turning the adapter 120, bringing about an improvement in the operability of the microscope unit 1.

What is claimed is:

1. A microscope unit having a supplementary lens by means of which the distance between a view object and the viewing end of a microscope is adjustable, wherein;
the unit comprises an intermediate member which is attachable between the microscope viewing end and the supplementary lens and has a dimension in the direction of the optical axis; and
a first engagement part which is detachably fastenable to a lens attachment part at the microscope viewing end and a second engagement part which is detachably fastenable to the supplementary lens are formed in the intermediate member.

2. A microscope unit having a supplementary lens by means of which the distance between a view object and the viewing end of a microscope is adjustable, wherein;
the unit comprises one intermediate member which is attachable between the microscope viewing end and the supplementary lens and is selected from a plurality of intermediate members each having a different dimension in the direction of the optical axis;
and a first engagement part which is detachably fastenable to a lens attachment part at the microscope viewing end and a second engagement part which is detachably fastenable to the supplementary lens are formed in the intermediate member.

3. A microscope unit having a supplementary lens by means of which the distance between a view object and the viewing end of a microscope is adjustable, wherein;
the unit comprises an intermediate member which is attachable between the microscope viewing end and the supplementary lens and has a plurality of ring members standing connected, each having a different dimension in the direction of the optical axis; and
i) a microscope-side attachment part having a first engagement part which is detachably fastenable to a lens attachment part at the microscope viewing end and ii) a supplementary-lens-side attachment part having a second engagement part which is detachably fastenable to the supplementary lens and being attached to the microscope-side attachment part movably in the direction of the optical axis are provided in the ring members of the intermediate member.
